(19) United States
(12) Patent Application Publication
(10) Pub. No.: US 2025/0140979 A1
(43) Pub. Date: May 1, 2025

(54) BATTERY SYSTEM WITH IMPROVED COOLING SYSTEM

(71) Applicant: SAMSUNG SDI CO., LTD., Yongin-si (KR)

(72) Inventor: Eymen IPEK, Graz (AT)

(21) Appl. No.: 18/771,804

(22) Filed: Jul. 12, 2024

(30) Foreign Application Priority Data
Oct. 31, 2023 (EP) 23207037.5

(51) Int. Cl. H01M 10/6568; H01M 10/613; H01M 10/625

(52) U.S. Cl. CPC H01M 10/6568; H01M 10/613; H01M 10/625

(57) ABSTRACT

A battery system includes at least three battery units. Each of the battery units includes a battery cell and a cooling channel segment, and the cooling channel segment forms part of a cooling circuit of the battery system. The battery units are arranged in one or more rows such that each of the battery units faces at least one of the other battery units in the same or in another row, and at least two of the battery units that do not face each other are connected in series with one another via a respective cooling channel segment.

### CROSS-REFERENCE TO RELATED APPLICATION

The present application claims priority to and the benefit of European Patent Application Ser. No. 23/207,037.5, filed on Oct. 31, 2023, in the European Patent Office, the entire disclosure of which is incorporated herein by reference.

### BACKGROUND

### 1. Field

Aspects of embodiments of the present disclosure relate to a battery system with an improved cooling system.

### 2. Description of the Related Art

In recent years, vehicles for transportation of goods and people have been developed that use electric power as a source for motion. Such an electric vehicle is an automobile that is propelled by an electric motor using energy stored in rechargeable batteries. An electric vehicle may be solely powered by batteries (a Battery Electric Vehicle (“BEV”)), or may include a combination of an electric motor and, for example, a conventional combustion engine (a Plugin Hybrid Electric Vehicle (“PHEV”)). BEVs and PHEVs use high-capacity rechargeable batteries, which are designed to provide power for propulsion over sustained periods of time.

Generally, a rechargeable (or secondary) battery cell includes an electrode assembly including a positive electrode, a negative electrode, and a separator interposed between the positive and negative electrodes. A solid or liquid electrolyte allows for movement of ions during charging and discharging of the battery cell. The electrode assembly is located in (or accommodated in) a casing, and electrode terminals, which are positioned on the outside of the casing, establish an electrically conductive connection to the aforementioned electrodes. The shape of the casing may be, for example, cylindrical or rectangular.

A battery module is formed of (or includes) a plurality of battery cells connected to each other in series or in parallel. That is, the battery module is formed by interconnecting the electrode terminals of the plurality of battery cells depending on a desired amount of power and to realize a high-power rechargeable battery.

Battery modules can be constructed in either a block design or in a modular design. In the block design, each battery cell is coupled to a common current collector structure and a common battery management system, and the unit thereof is arranged in a housing. In the modular design, pluralities of battery cells are connected together to form submodules, and several submodules are connected together to form the battery module. In automotive applications, battery systems generally include a plurality of battery modules connected to each other in series to provide a desired voltage.

A battery pack is a set of any number of (often identical) battery modules or single battery cells. The battery modules may, for example, be connected together in series, parallel, or a mixture of both to provide the desired voltage, capacity, and/or power density. Components of a battery pack include the individual battery modules and interconnects, which provide electrical conductivity between the battery modules.

To provide thermal control of the battery cells within the battery housing, a thermal management system may be used to efficiently emit, discharge, and/or dissipate heat generated by its rechargeable batteries. If the heat emission, discharge, and/or dissipation is not sufficiently performed, temperature deviations may occur between respective battery cells, such that the battery module may no longer generate a desired (or designed) amount of power. In addition, an increase of the internal temperature can lead to abnormal reactions occurring in the battery cells. Hence, the charging and discharging performance of the rechargeable battery may deteriorate and the lifespan of the rechargeable battery may be shortened. Thus, battery cell cooling by effectively emitting, discharging, and/or dissipating heat from the battery cells is important.

Exothermic decomposition of cell components may lead to a so-called thermal runaway. Generally, thermal runaway describes a process that accelerates due to increased temperature, in turn releasing energy that further increases temperature. Thermal runaway occurs in situations when an increase in temperature changes the conditions in a way that causes a further increase in temperature, often leading to a destructive result. In rechargeable battery systems, thermal runaway is associated with strong exothermic reactions that are accelerated by temperature rise. In thermal runaway, the battery cell temperature rises incredibly fast and the energy stored is released very suddenly. In extreme cases, thermal runaway can cause battery cells to explode and start fire. In minor cases, it can cause battery cells to be damaged beyond repair.

For example, when a battery cell is heated above a critical temperature (typically above about 150° C.) the battery cell can transition into a thermal runaway. Generally, temperatures outside of the safe region on either the low or high side may lead to irreversible damage to the battery cell and, therefore, may possibly trigger thermal runaway. Thermal runaway may also occur due to an internal or external short circuit of the battery cell or poor battery maintenance. For example, overcharging or rapid charging of the battery cell may lead to thermal runaway.

During thermal runaway, a failed battery cell, that is, a battery cell having a local failure, may reach temperatures exceeding about 700° C. Further, large quantities of hot gas are ejected from inside of the failed battery cell through a venting opening in the cell housing into the battery pack. The main components of the vented gas are H₂, CO₂, CO, electrolyte vapor, and other hydrocarbons. Moreover, the vented gas is flammable and potentially toxic. The vented gas may also cause a gas-pressure increase inside the battery pack. In the worst case, the high temperatures may lead to the process spreading to neighboring cells and potentially resulting in a fire in the battery pack. At this stage, the fire is difficult to extinguish.

A battery cell or battery pack experiencing a thermal runaway may transfer heat to neighboring battery cells or battery packs through thermal propagation. Such heat may be transferred conductively through the respective battery housings encasing the battery cells or battery packs. Additionally, such heat maybe transferred through any crossbeams which may be arranged between battery packs and also through electrical connecting components (e.g., cables and busbars). To counter such thermal propagation, battery systems may be provided with cooling systems that pump cooling fluid through cooling channels along, for example, a bottom side of the battery cells.

However, thermal propagation may also occur through the cooling system because, while the cooling fluid cools down the battery cell experiencing the thermal runaway, the cooling fluid itself may be heated to critical temperatures. Such thermal propagation is often overlooked in known battery systems.

### SUMMARY

Embodiments of the present disclosure overcome or mitigate at least some of the drawbacks of the prior art and provide a battery system with an improved cooling system that more securely handles a thermal runaway of one or more of its battery cells without damaging components of the battery system.

The present disclosure is defined by the appended claims and their equivalents The description that follows is subject to this limitation. Any disclosure lying outside the scope of said claims and their equivalents is intended for illustrative as well as comparative purposes.

According to an embodiment of the present disclosure, a battery system includes at least three battery units. Each of the battery units includes one or more battery cells and a cooling channel segment, and the cooling channel segment forms part of a cooling circuit of the battery system. The battery units are arranged in at least one row such that each of the battery units faces at least one of the other battery units in the same or in another row, and at least two of the battery units that do not face each other are connected in series with one another via a respective cooling channel segment.

According to an embodiment of the present disclosure, the battery system may include at least six battery units. The battery units may be arranged in a plurality of rows, and the battery units may be arranged such that each of the battery units faces at least one other battery unit in the same row and one other battery unit in another row.

According to an embodiment of the present disclosure, the battery units in a first row from among the rows may be connected in parallel via a respective cooling channel segment.

According to an embodiment of the present disclosure, the battery units in a second row from among the rows may be connected in parallel via a respective cooling channel segment.

According to an embodiment of the present disclosure, only ones of the battery units that do not face each other and that are in different rows may be connected to each other in series via cooling channel segments.

According to an embodiment of the present disclosure, from among the battery units in the same row, only the next but one of the battery units may be connected with one another in series via the respective cooling channel segment.

According to another embodiment of the present disclosure, an electric vehicle may include a battery system as described above.

Further aspects and features of the present disclosure can be learned from the dependent claims or the following description.

### BRIEF DESCRIPTION OF THE DRAWINGS

Aspects and features of the present disclosure will become apparent to those of ordinary skill in the art by describing, in detail, embodiments with reference to the attached drawings, in which:

FIGS. 1A and 1B are schematic top views of related art battery systems in which adjacent battery units are connected together in series.

FIG. 2 is a schematic top view of a battery system according to an embodiment of the present disclosure.

FIG. 3 is a schematic top view of a battery system according to another embodiment of the present disclosure.

### DETAILED DESCRIPTION

Reference will now be made, in detail, to embodiments, examples of which are illustrated in the accompanying drawings. Aspects and features of the embodiments, and implementation methods thereof, will be described with reference to the accompanying drawing. The present disclosure, however, may be embodied in various different forms and should not be construed as being limited to the embodiments illustrated herein. Rather, these embodiments are provided as examples so that this disclosure will be thorough and complete and will fully convey the aspects and features of the present disclosure to those skilled in the art.

Accordingly, processes, elements, and techniques that are not considered necessary for those having ordinary skill in the art to have a complete understanding of the aspects and features of the present disclosure may not be described. In the drawing, the relative sizes of elements, layers, and regions may be exaggerated for clarity. For example, in the drawings, the size or thickness of each element may be arbitrarily shown for illustrative purposes, and thus the embodiments of the present disclosure should not be construed as being limited thereto.

As used herein, the term “and/or” includes any and all combinations of one or more of the associated listed items. Further, the use of “may” when describing embodiments of the present disclosure refers to “one or more embodiments of the present disclosure.” In the following description of embodiments of the present disclosure, the terms of a singular form may include plural forms unless the context clearly indicates otherwise.

It will be understood that although the terms “first” and “second” are used to describe various elements, these elements should not be limited by these terms. These terms are only used to distinguish one element from another element. For example, a first element may be named a second element and, similarly, a second element may be named a first element, without departing from the scope of the present disclosure. Expressions such as “at least one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively.

As used herein, the term “substantially,” “about,” and similar terms are used as terms of approximation and not as terms of degree and are intended to account for the inherent deviations in measured or calculated values that would be recognized by those of ordinary skill in the art. Further, if the term “substantially” is used in combination with a feature that could be expressed using a numeric value, the term “substantially” denotes a range of +/−5% of the value centered on the value.

It will be further understood that the terms “include,” “comprise,” “including,” or “comprising” specify a property, a region, a fixed number, a step, a process, an element, a component, and a combination thereof but do not exclude other properties, regions, fixed numbers, steps, processes, elements, components, and combinations thereof.

It will also be understood that when a film, a region, or an element is referred to as being “above” or “on” another film, region, or element, it can be directly on the other film, region, or element, or intervening films, regions, or elements may also be present.

In the following description of embodiments of the present disclosure, the terms of a singular form may include plural forms unless the context clearly indicates otherwise.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

According to an embodiment of the present disclosure, a battery system is provided. The battery system includes a housing that accommodates at least three battery units inside it, forming a battery housing. The battery units each include at least one battery cell, for example, a plurality of battery cells, and a cooling channel segment. Thus, a battery unit may include only one battery cell. Also, a battery unit may include a plurality of battery cells which may be interconnected through electrical connectors, such as busbars, contacting respective electrode terminals or battery cell terminals to form one or more battery modules or battery packs. Thus, the battery cells of one battery unit may be arranged to form a battery pack or battery module. The battery cells may be, for example, prismatic or cylindrical cells. Each of the battery units may have a venting exit at a venting side of the battery unit, which may be (or may correspond to) the terminal sides of the battery units. The venting exits allows a venting gas stream to escape (or exit) the battery units during a thermal runaway. Venting valves may be provided at (or in) the venting exits. The venting side may be the top side and/or the bottom side of the battery unit. That is, venting exits may be provided at the top side and/or the bottom side of the battery unit.

The cooling channel segment forms part of a cooling circuit or cooling system of the battery system. The terms “cooling circuit” and “cooling system” may be used interchangeably. The battery system may include a cooling circuit that includes a cooling channel extending along a side, for example, the bottom side, of the battery unit. The cooling channel connects from a supply line for supplying cooling fluid to the cooling channel to a return line for returning or discharging the cooling fluid from the cooling channel. The cooling channel segment of the battery unit is the part of the cooling channel that extends along a side, for example, the bottom side, of the at least one battery cell of the battery unit for cooling the battery unit. Thus, the battery unit may be cooled by the cooling circuit that pumps (or moves) cooling fluid through the supply line along the cooling channel, through the respective cooling channel segments, and out of the return line. The battery unit, that is, the battery cells included in the battery unit, thus transfer heat to the cooling fluid during a thermal runaway.

The battery units are arranged in at least one row. The battery units are lined up or, in other words, may be arranged sequentially, in at least one row. In such an arrangement, each of the battery units faces at least one of the other battery units. Each of the battery units faces at least one of the other battery units of the same or of another row. For example, the battery units are arranged such that each of the battery units includes at least one side that faces a side of one of the other battery units. For example, two battery units facing each other implies that (or means that) no additional battery unit is arranged between the aforementioned two battery units. Such battery units facing each other may be considered adjacent or neighboring battery units. In other words, battery units that are arranged next to each other may be considered facing each other, that is, sharing at least one side (e.g., at least one common side). Hence, the battery units in one row may face at least one battery unit in the same row. Also, if more than one row of battery units is provided, the battery units in different rows may face each other, sharing at least one side. For example, a first battery unit may face a second battery unit arranged at its left side, may face a third battery unit arranged at its right side in the same row, and may also face a fourth battery unit in an adjacent or neighboring row.

According to embodiments of the present disclosure, at least two of the battery units are connected in series with one another through their respective cooling channel segments such that only those battery units that do not face each other are connected in series (e.g., are thermally connected in series). Battery units being connected in series with one another through their cooling channel segments indicates that the cooling channel segments of these battery units are connected with one another. That is, according to embodiments of the present disclosure, the cooling channel segments of at least two of the battery units are connected in series, with only those cooling channel segments of those aforementioned battery units that do not face each other being connected in series. Thus, the connected battery units are fluidly connected. From among the battery units included in the battery system, those that are not facing each other, that is, those battery units that are not adjacent to or neighboring each other, may be connected in series through their cooling channels. In other words, neighboring or adjacent battery units are not connected in series through their cooling channel segments. Hence, those neighboring or adjacent battery units may instead be connected in parallel or not connected to each other at all.

By connecting the battery units that are not facing each other, that is, are not neighboring each other, in series through their cooling channel segments, heat conduction and heat convection transfers are kept separate. If one of the battery units undergoes a thermal runaway, the affected battery unit heats up to high temperatures (up to about 1000° C.). The heat generated is then transferred to the cooling fluid and is transported away by heat convection through the cooling fluid along the cooling circuit. The cooling fluid leaving the battery unit experiencing thermal runaway does not enter adjacent or neighboring battery units due to the lack of a series connection to these adjacent or neighboring battery units. Hence, the neighboring battery units are not heated up by the cooling fluid which otherwise, due to the thermal runaway, may at this stage also have an undesirable high temperature. The neighboring battery units may experience heat transfer from the battery unit undergoing the thermal runaway by heat conduction through, for example, the unit housing encasing the respective battery units and/or through crossbeams that may separate the neighboring battery units. On the other hand, while the battery units in series connection with the battery unit experiencing the thermal runaway may be heated up convectively by the cooling fluid, these series connected battery units are not adjacent to or neighboring the battery unit experiencing the thermal runaway. Hence, they are not heated conductively or at least not as much. Thus, heat conduction and heat convection transfer between the battery units are separated, allowing the heat energy of the failed battery unit or battery cell to be distributed across a larger heat capacity. Therefore, an improved cooling system is realized such that the battery units of the battery system according to embodiments of the present disclosure may securely handle a thermal runaway of one or more of its battery cells, thereby reducing thermal propagation between the battery units.

According to some embodiments of the present disclosure, the battery system may include at least six battery units are arranged in at least two rows. In each row, the battery units may be configured as described above. The battery units may be arranged such that each of the battery units faces at least one other battery unit in the same row and one other battery unit in another row. Further, at least two of the battery units may be connected in series with one another through their cooling channel segments, such that those battery units that do not face each other are connected in series. Thus, two battery units in different rows are connected in series. Also, a battery unit may be connected in series with one or more battery units in the same row and with one or more battery units in another row. For such an arrangement, the cooling architecture according to embodiments of the present disclosure is advantageous. Thermal propagation through convection and through conduction is separated for battery units in two different rows.

According to some embodiments, the battery units in a first row of the at least two rows may be connected in parallel through their cooling channel segments and/or the battery units in a second row of the at least two rows may be connected in parallel through their cooling channel segments. Hence, battery units in different rows are connected in series while the battery units in the same row are connected in parallel. So, the battery units in the same row experience heat conduction but not heat convection. For example, battery units that do not face each other and are in different rows are connected in series. In other words, from among the battery units in different rows, those battery units that do not face each other are connected in series. A first battery unit in a first row may be connected in series to a second battery unit in a second row through their cooling channel segments. For example, battery units in different rows that are arranged diagonally across from each other may be connected in series. Thus, heat conduction and heat convection transfer between the battery units are separated and the heat energy of the failed battery unit or battery cell can be distributed across a larger heat capacity.

According to some embodiments, from among the battery units in the same row, only the next but one of the battery units are connected with one another in series through their cooling channel segments. In other words, every second battery unit may be connected to every other second battery unit. Hence, no adjacent or neighboring battery units are connected in series. Thus, it may be advantageous for both a single row of battery units as well as for multiple rows of battery units.

Therefore, heat conduction and heat convection transfer between the battery units may be separated and the heat energy of the failed battery unit or battery cell may be distributed across a larger heat capacity.

Embodiments of the present disclosure also provide an electric vehicle including a battery system as described above.

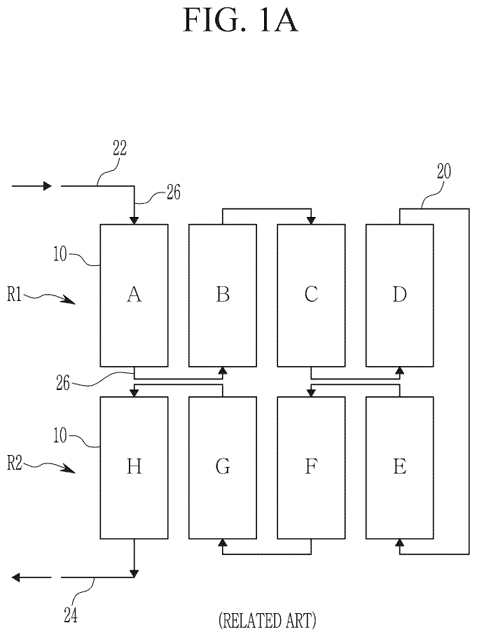

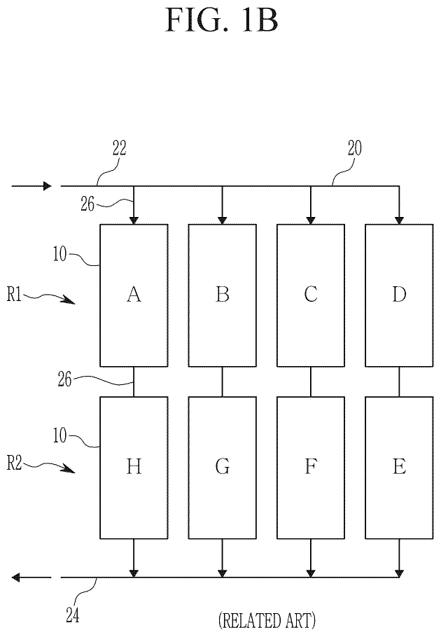

FIG. 1A is a top view schematic illustrating a related art battery system including a plurality of battery units 10 arranged in two rows R1 and R2. In the battery system shown in FIG. 1A, row R1 includes four battery units A, B, C, and D, and row R2 includes four battery units E, F, G, and H. The battery units 10 may each include one or more battery cells.

The battery units 10 are arranged such that each of the battery units 10 faces at least one of the other battery units 10 of the same and also of the other row. For example, the battery unit B faces at a first (or left) side, the battery unit A, at a second (or right) side, the battery unit C, and at a third (or below) side, the battery unit G. That is, no battery unit is arranged in between the battery unit B and the battery unit A, in between battery the unit B and the battery unit C, and also not in between the battery unit B and the battery unit G. Thus, the battery units A, C, and G may be considered adjacent to or neighboring the battery unit B.

Further, the battery units 10 include cooling channel segments 26 that form part of a cooling channel 20 of a cooling circuit of the battery system. The cooling circuit includes the cooling channel 20, which extends below the battery units 10 along a bottom side of the battery units 10, a supply line 22 for supplying a cooling fluid to the cooling channel 20, and a return line 24 for returning or discharging the cooling fluid from the cooling channel 20. Cooling plates may be integrated into the cooling channel 20 at the bottom sides of the battery units 10.

Arrows drawn along the cooling channel 20 indicate the direction in which the cooling fluid flows through the cooling channels 20 and, thus, through the battery units 10. As shown in FIG. 1A, all of the battery units 10 are connected in series with one another through their cooling channel segments 26, creating a connection (e.g., a thermal connection) through the cooling channel 20. That is, the cooling fluid entering the cooling channel 20 through the supply line 22 flows first through battery unit A, then through battery unit B, then through battery unit C, and so forth until the cooling fluid leaves the battery unit H and reaches the return line 24. In other words, all of the battery units 10 in the battery system shown in FIG. 1A are fluidly connected in series in terms of the cooling fluid. Described in more detail below, the battery units 10 being connected with one another indicates a fluid connection through their cooling channel segments 26 and, thus, through the cooling channel 20.

Such a series connection of battery units 10 may be susceptible to or prone to thermal propagation during a thermal runaway event.

For example, the battery unit B may experience a thermal runaway resulting in the battery unit B heating up to temperatures of many hundreds of degrees Celsius. Heat may then be transferred conductively from the battery unit B to the adjacent battery units A, C, and G through housings of the respective battery units and any crossbeams arranged between the aforementioned battery units. This may lead to the battery units A, C, and G heating up as well.

Further, due to the series connection of the battery units 10 through their cooling channel segments 26, the battery unit C experiences a further increase in heat as it directly follows the battery unit B in the flow of the cooling fluid. That is, the cooling fluid leaving the battery unit B along the indicated flow direction subsequently enters the adjacent battery unit C, and thus convectively heats the battery unit C. This may lead to the battery unit C heating up to temperatures that may damage the battery unit C and may even, in the worst case, result in a thermal runaway of the battery unit C. The battery units located farther down (or farther along) the cooling channel 20, for example, battery unit D, may experience the same problem depending on the temperature of the cooling fluid as it reaches the subsequent battery units. Embodiments of the present disclosure overcome this problem of thermal propagation as explained below.

As another related art example of a battery system cooling architecture, FIG. 1B shows an arrangement of battery units 10 in which the battery units A, B, C, and D of the first row R1 are connected in parallel through their cooling channel segments 26 and the cooling channel 20. Similarly, the battery units E, F, G, and H of the second row R2 are connected in parallel. Further, the battery units A, B, C, and D of the first row R1 are connected in series with the battery units E, F, G, and H of the second row R2. That is, the battery unit A is connected in series with the battery unit H, the battery unit B is connected in series with the battery unit G, and so on.

In this related art example, the problem of thermal propagation may occur as well. For example, the battery unit B may experience a thermal runaway resulting in the battery unit B heating up to temperatures of many hundreds of degrees Celsius. Heat from the battery unit B may then be transferred conductively to the adjacent battery units A, C, and G, for example, through housings of the respective battery units 10 and any crossbeams arranged between the battery units 10. This may lead to the battery units A, C, and G to heat up as well, similar to the previous example described in connection with FIG. 1A.

Further, due to the series connection of the battery unit B with the battery unit G, the battery unit G may experience further heating as it is arranged downstream of (or below) the battery unit B in terms of the cooling fluid. That is, the cooling fluid leaving the battery unit B along the indicated flow direction subsequently enters the adjacent battery unit G. This may lead to the battery unit G heating up to temperatures that may damage the battery unit G and may even, in the worst case, result in a thermal runaway of the battery unit G. Embodiments of the present disclosure overcome this problem of thermal propagation as explained below.

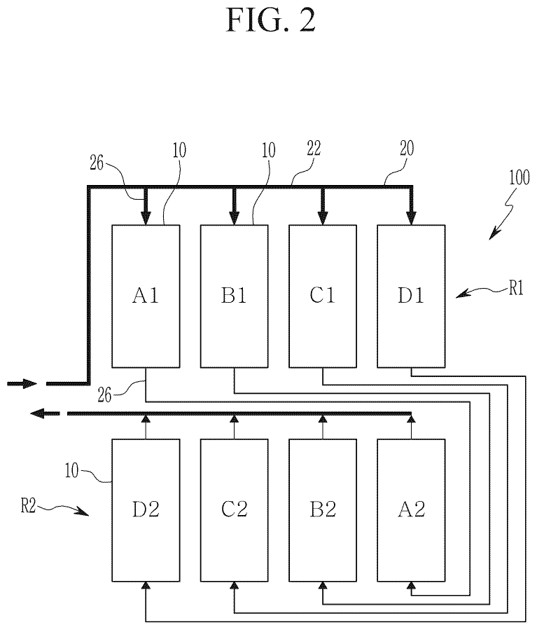

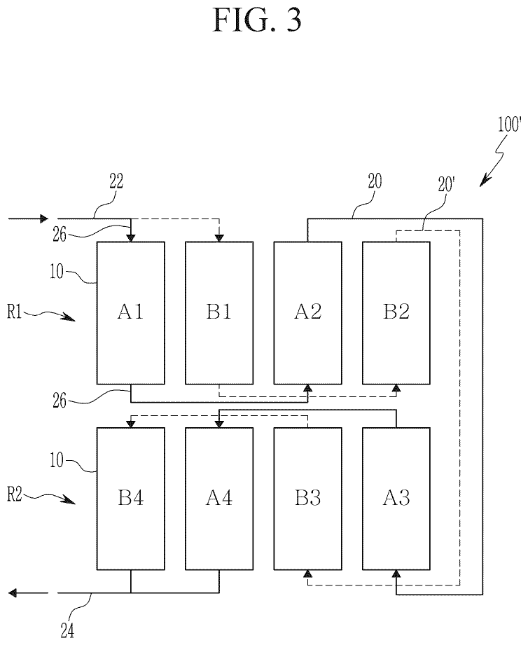

FIGS. 2 and 3 show respective embodiments of a battery system according to the present disclosure, which include a cooling architecture that mitigates or overcomes the problem of thermal propagation described above.

As shown in FIG. 2, a battery system 100 includes a plurality of battery units 10. In the first row R1, battery units A1, B1, C1, and D1 are connected in parallel through their cooling channel segments 26 and, thus, through the cooling channel 20. Also, the battery units A2, B2, C2, and D2 of the second row R2 are connected in parallel. Further, the battery units A1, B1, C1, and D1 of the first row R1 are respectively connected in series with the battery units A2, B2, C2, and D2 of the second row R2. However, while there is a series connection between the battery units 10 of the first row R1 and the battery units 10 of the second row R2, only those battery units 10 that do not face each other are connected in series. In other words, the battery system 100 shown in FIG. 2 does not include any adjacent or neighboring battery units 10 that are connected in series through their cooling channel segments 26 and, thus, through the cooling channel 20.

As shown in FIG. 2, battery unit B1 in row R1 is connected in series only to battery unit B2 in row R2, such that the battery unit B1 and the battery unit B2 do not face each other. In other words, battery unit B1 in row R1 and battery unit B2 in row R2 are not adjacent to nor neighbor each other. If the battery unit B1 experiences a thermal runaway, heat from the battery unit B1 may be transferred conductively to the adjacent battery units A1, C1, and C2 through, for example, housings of the respective battery units 10 and any crossbeams arranged between the battery units 10. However, none of these adjacent battery units A1, C1, and C2 are heated convectively through the cooling fluid because none of the adjacent battery units A1, C1, and C2 are connected in series to the battery unit B1 via the cooling channel 20. Rather, only the battery unit B2 receives the cooling fluid heated up by the battery unit B1 due to their series connection of the cooling channel 20. Thus, the battery unit B2 may heat up convectively but, because the battery unit B2 does not face the battery unit B1, that is, the battery unit B1 is not adjacent to or neighboring the battery unit B1, there is no heat conduction from the battery unit B1 to the battery unit B2 or at least much less heat conduction from the battery unit B1 to the battery unit B2.

Thus, in the battery system 100 shown in FIG. 2, heat transfer through conduction and heat transfer through convection from one battery unit 10 to another battery unit 10 are separated. During a thermal runaway of one battery unit 10, the battery units 10 that are farther away may be heated up conductively or convectively but not both. Thus, thermal propagation and, thus, the risk of propagation of a thermal runaway is reduced.

Referring to FIG. 3, a battery system 100′ according to another embodiment of the present disclosure includes a plurality of battery units 10, and the battery units A1 and A2 in the first row R1 and the battery units A3 and A4 in the second row R2 are fluidly connected in series through their cooling channel segments 26 and through the cooling channel 20. For example, the battery unit A2 is subsequently connected in series to battery unit A1, the battery unit A3 is subsequently connected in series to the battery unit A2, and the battery unit A4 is subsequently connected in series to the battery unit A3. Correspondingly, the battery units B1, B2, B3, and B4 are connected in series through their cooling channel segments 26 and through the cooling channel 20′. Thus, from the battery units 10 in the same row R1 and R2, only the next one battery unit 10 is connected with one another in series through their cooling channel segments 26. For example, the battery unit B1 is connected in series not with the next (or neighboring) battery unit A2 but with the next battery unit B2. In this regard, the two separate cooling channels 20 and 20′ are formed such that the flow of cooling liquid along cooling channel 20 is shown by a continuous line and the flow of cooling liquid along the cooling channel 20′ is shown by a dashed line. The cooling channels 20 and 20′ may form part of the same cooling circuit having a common supply line 22 and a common return line 24 for both cooling channels 20 and 20′, as shown in FIG. 3.

In some embodiments, if battery unit B1 experiences a thermal runaway, the battery units facing the battery unit B1 may be heated up through conduction. That is, the battery units A1, A2, and A4 may be heated up via heat transfer through conduction from the battery unit B1. These battery units are not heated convectively, however, as they are not connected in series with the battery unit B1. The heated up cooling fluid leaving the battery unit B1 flows to the battery unit B2, arranged subsequently in the series connection to the battery unit B1 so that the battery unit B2, and possibly the further away battery units B3 and B4 of the series connection, are heated up convectively. All of the battery units B2 to B4 that are in series connection with the battery unit B1 do not face the battery unit B1. That is, the battery units B2 to B4 are not adjacent to or neighboring the battery unit B1 and, therefore, are not heated up conductively by heat transfer through the battery unit housing and crossbeams, or at least not as much.

Also, in the battery system 100′ shown in FIG. 3, heat transfer through conduction and heat transfer through convection from one battery unit 10 to another battery unit 10 are separated. During a thermal runaway of one battery unit 10, the further away battery units 10 may be heated up conductively or convectively but not both. Thus, thermal propagation and thus the risk of propagation of a thermal runaway is reduced.

Some Reference Symbols

| | | | |
|---|---|---|---|
| 10 | battery units | 20 | cooling channel |
| 20’ | cooling channel | 22 | supply line |
| 24 | return line | 26 | cooling channel segments |
| 100 | battery system | 100’ | battery system |
| R1 | row 1 | R2 | row 2 |

What is claimed is:

1. A battery system comprising:
at least three battery units, each of the battery units comprising a battery cell and a cooling channel segment, the cooling channel segment forming part of a cooling circuit of the battery system,
wherein the battery units are arranged in one or more rows such that each of the battery units faces at least one of the other battery units in the same or in another row, and
wherein at least two of the battery units that do not face each other are connected in series with one another via a respective cooling channel segment.

2. The battery system as claimed in claim 1, the battery system further comprises at least six battery units,
wherein the battery units are arranged in a plurality of rows,
wherein the battery units are arranged such that each of the battery units faces at least one other battery unit in the same row and one other battery unit in another row.

3. The battery system as claimed in claim 2, wherein the battery units in a first row from among the rows are connected in parallel via a respective cooling channel segment.

4. The battery system as claimed in claim 2, wherein the battery units in a second row from among the rows are connected in parallel via a respective cooling channel segment.

5. The battery system as claimed in claim 2, wherein only ones of the battery units that do not face each other and that are in different rows are connected to each other in series via cooling channel segments.

6. The battery system as claimed in claim 1, wherein, from among the battery units in the same row, only the next but one of the battery units is connected with one another in series via the respective cooling channel segment.

7. An electric vehicle comprising the battery system as claimed in claim 1.
